(19) United States
(12) Patent Application Publication
(10) Pub. No.: US 2024/0017228 A1
(43) Pub. Date: Jan. 18, 2024

(54) PROCESS AND APPARATUS FOR SEPARATING CATALYST FROM PRODUCT GAS

(71) Applicant: UOP LLC, Des Plaines, IL (US)

(72) Inventors: Sakthivelan Maadasamy Durai, Gurugram (IN); Ashim Mandal, Gurgaon (IN); Sathit Kulprathipanja, Schaumburg, IL (US); Michael A. Stine, Lake Zurich, IL (US); Xin X. Zhu, Long Grove, IL (US)

(21) Appl. No.: 18/221,383

(22) Filed: Jul. 12, 2023

Related U.S. Application Data
(60) Provisional application No. 63/389,345, filed on Jul. 14, 2022.

(51) Int. Cl. B01J 8/00; B01J 8/18; B01D 45/16; B04C 5/28; B04C 9/00

(52) U.S. Cl. CPC B01J 8/0055; B01J 8/1854; B01D 45/16; B04C 5/28; B04C 9/00; B01J 2208/00991; B01J 2208/00761

(57) ABSTRACT

A process and apparatus for catalytic conversion of feedstock and separating catalyst from product gas comprises a first hydrocarbon feedstock contacted with a first stream of catalyst in a first riser to produce a first mixture of catalyst and product gases. A second hydrocarbon feedstock is contacted with a second stream of catalyst in a second riser to produce a second mixture of catalyst and product gases. The first riser and/or the second riser may terminate within a reactor vessel. The first mixture of catalyst and product gases from the first riser pass into a first disengagement chamber within the reactor vessel. The second mixture of catalyst and product gases pass from the second riser into a second disengagement chamber within the same reactor vessel.

### CROSS-REFERENCE TO RELATED APPLICATIONS

This application claims priority from U.S. Provisional Application No. 63/389,345, filed Jul. 14, 2022, which is incorporated herein in its entirety.

### FIELD

The field is the reaction of feed with fluid catalyst. The field particularly relates to separating product gas from the fluid catalyst.

### BACKGROUND

Cyclonic methods for the separation of solids from gases are well known and commonly used in fluid catalytic processes. A particularly well-known application of such methods is in the hydrocarbon processing industry where particulate catalysts contact gaseous reactants to effect chemical conversion of the gas stream components or physical changes in the particles undergoing contact with the gas stream.

Among fluid catalytic process, the FCC process presents a familiar example of a process that uses gas streams to contact a finely divided stream of catalyst particles and effects catalytic conversion of the gas stream in contact with the particles.

Efficient separation of particulate catalyst from product vapors is very important in the FCC process. Particulate catalyst that is not effectively separated from product vapors in the FCC unit must be separated downstream either by filtration methods or additional separation devices that multiply separation devices utilized in the FCC unit. Additionally, catalyst that is not recovered from the FCC process represents a two-fold loss. The catalyst must be replaced, representing a material cost, and unrecovered catalyst may cause erosion to downstream equipment. Severe erosion may cause equipment failure and subsequent lost production time. Accordingly, methods of efficiently separating particulate catalyst materials from gaseous fluids in an FCC process are of great utility.

In the FCC process, product gases are separated from particulate catalyst solids as they are discharged from a reaction conduit. The most common method of separating particulate solids from a gas stream uses centripetal separation. Centripetal separators operate by imparting a tangential velocity to gases containing entrained solid particles that forces the heavier solids particles outwardly away from the lighter gases for upward withdrawal of gases and downward collection of solids.

An arrangement for initial quick centripetal separation tangentially discharges a mixture of product gases and solid catalyst from a riser into a disengagement vessel. The disengagement vessel provides a first separation of solids from gases. In these arrangements, the initial stage of separation is typically followed by a second more compete separation of solids from gases in a traditional cyclone device.

Another method of obtaining this initial quick separation involves discharging product gases from a riser through an arcuate, tubular swirl duct which imparts a swirling, helical motion to the product gas and particulate catalyst as they enter a disengagement vessel. The swirling, helical motion of the materials in the disengagement vessel effect an initial separation of the particulate catalyst from the gases. The product gas with a light loading of entrained catalyst rises up a gas recovery conduit and is drawn into cyclones to effect further separation of the particulate catalyst from the product gases.

Cyclones usually comprise an inlet that is tangential to the outside of a cylindrical vessel that forms an outer wall of the cyclone. In the operation of an FCC cyclone, the entry and the inner surface of the outer wall cooperate to create a spiral flow path of the gaseous materials and catalyst that establishes a vortex in the cyclone. The centripetal acceleration associated with an exterior of the vortex causes catalyst particles to migrate towards the outside of the barrel while the gaseous materials enter an interior of the vortex for eventual discharge through an upper outlet. The heavier catalyst particles accumulate on the side wall of the cyclone barrel and eventually drop to the bottom of the cyclone and out via an outlet and a dipleg conduit for recycle through the FCC apparatus.

US20150005553A1 provides a disengagement device that can accommodate the effluent of two or more reactors or other sources of solid particles mixed with gases in order to effect a separation.

There is need for a single separation process and apparatus that can accommodate two or more distinct streams of product gases and solid catalyst particles.

### BRIEF SUMMARY

The disclosure pertains to a process and apparatus for catalytic conversion of feedstock and separating catalyst from product gas. A first hydrocarbon feedstock is contacted with a first stream of catalyst in a first riser to produce a first mixture of catalyst and product gases. A second hydrocarbon feedstock is contacted with a second stream of catalyst in a second riser to produce a second mixture of catalyst and product gases. The first riser and/or the second riser may terminate within a reactor vessel. The first mixture of catalyst and product gases from the first riser pass into a first disengagement chamber within the reactor vessel. The second mixture of catalyst and product gases from the second riser pass into a second disengagement chamber within the same reactor vessel.

Additional details and embodiments of the invention will become apparent from the following detailed description of the invention.

### BRIEF DESCRIPTION OF THE DRAWINGS

FIG. 1 is a sectional, elevational of the process and apparatus of the present disclosure;

FIG. 2 is an enlarged, plan view of FIG. 1 taken at segment 2-2;

FIG. 3 is a sectional, elevational of an alternative process and apparatus of the present disclosure;

FIG. 4 is an enlarged, plan view of FIG. 3 taken at segment 4-4; and

FIG. 5 is an enlarged, alternative plan view of FIG. 1 taken at segment 2-2.

### DEFINITIONS

The term “downstream communication” means that at least a portion of fluid flowing to the subject in downstream communication may operatively flow from the object with which it fluidly communicates.

The term “upstream communication” means that at least a portion of the fluid flowing from the subject in upstream communication may operatively flow to the object with which it fluidly communicates.

The term “direct communication” means that fluid flow from the upstream component enters the downstream component without passing through any other intervening vessel.

The term “indirect communication” means that fluid flow from the upstream component enters the downstream component after passing through an intervening vessel.

The term “bypass” means that the object is out of downstream communication with a bypassing subject at least to the extent of bypassing.

As used herein, the term “predominant” or “predominate” means greater than 50%, suitably greater than 75% and preferably greater than 90%.

As used herein the term “tangential” means tangential or near tangential but not radial.

### DETAILED DESCRIPTION

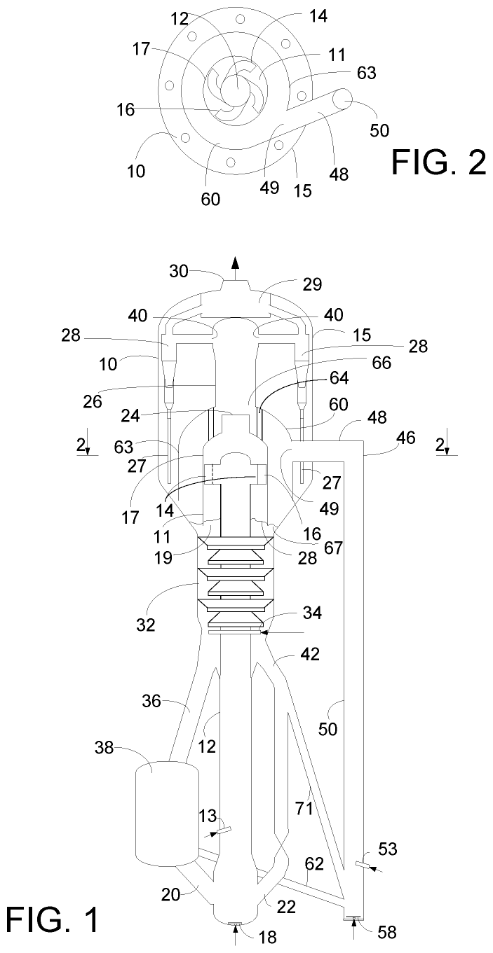

Looking at FIG. 1, the schematic illustration depicts a disengagement arrangement in a reactor vessel 10. A first reactor riser 12 extends upwardly from a lower portion of the reactor vessel 10 in an FCC arrangement. The first riser 12 preferably has a vertical orientation within the reactor vessel 10 and may extend upwardly from the bottom of the reactor vessel or downwardly from the top of the reactor vessel.

A first hydrocarbon feedstock is distributed into the first riser 12 from a feed distributor 13 or more near the base of the riser. A first stream of catalyst may be fluidized with steam distributed from a distributor 18 at a bottom of the first riser 12. The first hydrocarbon feedstock is contacted with a first stream of catalyst in the first riser 12. The first stream of catalyst may be provided by a mixture of a first stream of hot catalyst from a first hot catalyst pipe 20 and a first stream of recycle catalyst from a first recycle catalyst pipe 22. The first hydrocarbon feedstock vaporizes and converts or cracks to product gas comprising hydrocarbons of smaller molecular weight than the feedstock. Molar expansion and vaporization causes the first hydrocarbon feedstock and product gas to rapidly ascend the riser 12 entraining the first stream of catalyst as a first mixture of catalyst and product gas.

The first riser 12 terminates in an upper end of a first disengagement chamber 11 located within the reactor vessel 10 at a curved duct 14 or a plurality thereof. As best seen in FIG. 2, the curved duct 14 or a plurality thereof comprises a first discharge opening 16 contained in the first disengagement chamber 11. The first riser 12 is centrally longitudinally located in the first disengagement chamber 11. The first discharge opening 16 centrifugally discharges a first mixture of product gas and catalyst into the first disengagement chamber 11. By centrifugal discharge, the first mixture is discharge from inwardly to outwardly.

Centrifugal discharge of gases and catalyst from the first discharge opening 16 produces a swirling helical pattern about the interior of the first disengagement chamber 11 below the first discharge opening 16. Centrifugal acceleration associated with the helical motion forces the heavier catalyst particles toward a wall 17 of the first disengagement chamber 11 while the product gas ascends. The wall 17 of the first disengagement chamber 11 may be cylindrical. The dynamic effects disengagement of the first mixture of catalyst and product gas into a first stream of product gas and a first stream of disengaged catalyst in the first disengagement chamber 11. The first stream of disengaged catalyst from discharge opening 16 exits a first lower outlet 19 of the first disengagement chamber 11 and collects in the bottom and below the first disengagement chamber 11 in a dense catalyst bed 28. The first stream of product gas passes upwardly through a first upper outlet 24 and is discharged from the first disengagement chamber 11. In another embodiment, the first disengagement chamber 11 may not employ a centrifugal separation device but may employ a gravity or inertial separation device such as a ballistic separator. The wall 17 of first disengagement chamber 11 may not necessarily be cylindrical.

A distinct, second reactor riser 50 runs external to the reactor vessel 10. A second mixture of product gases and catalyst pass through the second riser 50 to the upper end 46 of the second riser 50. The upper end 46 transitions at a 90° elbow to provide a generally horizontal transfer conduit 48. The transfer conduit 48 intersects a wall 15 of the reactor vessel 10 and a wall 63 of a second disengaging chamber 60. The wall of the reactor vessel 10 and the wall 63 of the second disengagement chamber 60 may be cylindrical.

A second hydrocarbon feedstock is distributed into the second riser 50 from a feed distributor 53 or a plurality thereof near the base of the second riser. A second stream of catalyst may be fluidized with steam distributed from a distributor 58 at a bottom of the second riser 50. A steam flow rate of about 5 wt % to about 25 wt % of the second hydrocarbon stream may be added to the second riser 50. The second hydrocarbon feedstock is contacted with a second stream of catalyst in the second riser 50. The second stream of catalyst may be provided by a mixture of a second stream of hot catalyst from a second hot catalyst pipe 62 and a second stream of recycle catalyst from a second recycle catalyst pipe 71. The second hydrocarbon feedstock vaporizes and converts or cracks to product gas comprising hydrocarbons of smaller molecular weight than the feedstock. Molar expansion and vaporization causes the second hydrocarbon feedstock and product gas to rapidly ascend the second riser 50 entraining the second stream of catalyst as a second mixture of catalyst and product gas. The second stream of catalyst may comprise about 0.005 wt % to about 1.2 wt % coke.

The second riser 50 terminates in an upper end of the second disengagement chamber 60 located within the reactor vessel 10 at the horizontal transfer conduit 48. The horizontal transfer conduit 48 comprises a second discharge opening 49 contained in the second disengagement chamber 60. In an embodiment, the horizontal transfer line 48 of the second riser 50 terminates in the second disengagement chamber 60. The second discharge opening 49 tangentially discharges a second mixture of product gas and catalyst into the second disengagement chamber 60. In other embodiments, the horizontal transfer line 48 may be exchanged for an alternative connector such as a T-type connector or an elbow with a more acute or more obtuse angle. The eccentric scroll for the discharge inlet 49 of transfer conduit 48 may be between 0 and 180 degrees. The aspect ratio for the discharge inlet 49 may be between 0.1 and 10 and have a rectangular cross-sectional configuration. The wall 63 of the second disengagement chamber 60 may be about 1 to about 5 times the height of the discharge opening 49 below the discharge opening.

As best seen in FIG. 2, the horizontal transfer line 48 enters the reactor vessel 10, through the wall 15 and then tangentially enters the wall 63 of the second disengagement chamber 60 at the second discharge opening 49. The second discharge opening 49 is located in the wall 63 of the second disengagement chamber 60. Tangential discharge of the second mixture of catalyst and product gases through the second discharge opening 49 from the second riser 50 produces a swirling helical pattern about the interior of the second disengagement chamber 60. The second discharge opening 49 and the transfer line 48 can be tangential or near tangential, but not radial, to the wall 63 of the second disengagement chamber 60. The disengagement of the first mixture of catalyst and product gas into the first stream of product gas and the first stream of disengaged catalyst is conducted inwardly and concentrically of the disengagement of the second mixture of catalyst and product gas into the second stream of product gas and the second stream of disengaged catalyst.

The wall 17 of the first disengagement chamber 11 serves as an outer wall of the first disengagement chamber 11, but at the same time serves as an inner wall of the second disengagement chamber 60. The second disengagement chamber 60 is an annulus that surrounds and/or is annular to the first disengagement chamber 11. Both sides of the wall 17 of the first disengagement chamber 11 and the inner side of the wall 63 of the second disengagement chamber 60 may be provided with erosion resistant lining or coating to protect the metal against abrasion due to catalyst movement.

Generally, the cross-sectional area of the second discharge opening 49 may be smaller or similar to that of the upper end 46 of the second riser 50. The upper end 46 of the second riser 50 may be about 0.3 meters (1 foot) to about 2.74 meters (9 feet) in diameter. Preferably, the upper end of the reactor riser 50 may be about 0.91 meters (3 feet) to about 2.1 meters (7 feet) in diameter.

The swirling helical pattern followed by the product gases and catalyst discharged from the second discharge opening 49 may follow the same direction of swirl as the material from the first riser. Centripetal acceleration associated with the helical motion forces the heavier catalyst particles toward a wall 63 of the second disengagement chamber 60 while the lighter product gas easily changes direction and ascends. The dynamic effects disengagement of the second mixture of catalyst and product gas into a second stream of product gas and a second stream of disengaged catalyst in the second disengagement chamber 60. The disengagement of the second mixture of catalyst and product gas in the second disengagement chamber 60 is performed separately from the disengagement of the first mixture of catalyst and product gas in the first disengagement chamber 11.

Turning back to FIG. 1, the second stream of disengaged catalyst from the second discharge opening 49 exits a second lower outlet 67 of the second disengagement chamber 60 and collects in the bottom and below the second disengagement chamber 60 in the dense catalyst bed 28. The first lower outlet 19 of the first disengagement chamber 11 is located proximate to the second lower outlet 67 of the second disengagement chamber 60 at the lower end of the reactor vessel 10. The second lower outlet 67 of the second disengagement chamber 60 is annular to the first lower outlet 19 of the first disengagement chamber 11. The first stream of disengaged catalyst from the first disengaging chamber 11 and the second stream of disengaged catalyst from the second disengaging chamber 60 mix in the dense catalyst bed 28 below each disengaging chamber after the disengagement of the first stream of product gas from the first stream of disengaged catalyst and the disengagement of the second stream of product gas from the second stream of disengaged catalyst. The bottom edge of the second disengagement chamber 60 or sections thereof, and the bottom edge of the first disengagement chamber 11 or sections thereof are spaced from the shell 15 of the reactor vessel 10 to permit mixture between the first stream of disengaged catalyst and the second stream of disengaged catalyst in the dense catalyst bed 28 to provide a mixed stream of disengaged catalyst. The second stream of product gas passes upwardly through a second upper outlet 66 and is discharged from the second disengagement chamber 60.

The first upper outlet 24 of the first disengagement chamber 11 is located proximate to the second upper outlet 66 of the second disengagement chamber 60. The first upper outlet 24 and the second upper outlet 66 are both located below a gas recovery conduit 26. The first stream of product gas from the first upper outlet 24 and the second stream of product gas from the second upper outlet 66 both exit below a gas recovery conduit 26. Both the first stream of product gas and the second stream of product gas collect in and mix in the gas recovery conduit 26 after the disengagement of the first stream of product gas from the first stream of disengaged catalyst and the disengagement of the second stream of product gas from the second stream of disengaged catalyst. The mixed stream of product gas comprising the first stream of product gas and the second stream of product gas will usually contain a light loading of catalyst particles. The gas recovery conduit 26 recovers the mixed stream of product gas as well as stripping gases which are hereinafter described. The loading of catalyst particles in the gases entering conduit 26 are usually less than 16 grams/liter (1 lb/ft³) and typically less than 1.6 grams/liter (0.1 lb/ft³).

The first upper outlet 24 and the second upper outlet 66 are below a cyclone inlet 40 or a plurality thereof near an upper end of the gas recovery conduit 26 which may comprise a wider section of the gas recovery conduit. The gas recovery conduit 26 passes the mixed stream of product gases from the first upper outlet 24 and the second upper outlet 66 through cyclone inlet 40 into a cyclone 28 or through a plurality of cyclone inlets 40 through inlet ducts to respective cyclones 28. The cyclone 28 effects further removal of particulate material from the mixed stream of product gases from the gas recovery conduit 26. Each cyclone 28 may operate as a conventional direct connected cyclone in a conventional manner with the tangential entry of the gases creating a swirling action inside the cyclones to establish inner and outer vortexes that separate catalyst from gases. Cyclones 28 feed product gas with a lighter loading of catalyst through outlet ducts to a plenum 29 from which a product stream, relatively free of catalyst particles, exits the reactor vessel 10 through a reactor outlet 30.

Catalyst recovered by cyclones 28 exits the bottom of the cyclone through dipleg conduits 27 and pass to the bottom of the reactor vessel 10 where it collects with disengaged catalyst in the dense bed 28 that has exited the first disengagement chamber 11 and the second disengagement chamber 60. A lower edge of the wall 63 of the second disengagement chamber 60 or sections thereof do not descend to the wall 15 of the reactor vessel to allow catalyst from the dip legs 27 to pass to the bottom of the reactor vessel 10 and collect in the dense catalyst bed 28.

The first lower outlet 19 of the first disengagement chamber 11 and the second lower outlet 67 of the second disengagement chamber 60 may be located above a catalyst stripper section 32. The mixed stream of disengaged catalyst from the dense catalyst bed 28 passes downwardly through a stripping section 32. A stripping fluid, typically steam enters a lower portion of stripping section 32 through a distributor 34. Countercurrent contact of the catalyst with the stripping fluid through a series of stripping baffles, packing or grates displaces product gases from the catalyst as it continues downwardly through the stripping section 32. A first stream of stripped catalyst from the stripping section 32 passes through a regenerator conduit 36 to a catalyst heater or regenerator 38 that heats the catalyst by heat exchange or regenerates the catalyst by contact with an oxygen-containing gas. The catalyst heater or regenerator 38 provides the first stream of hot catalyst in the first hot catalyst pipe 20 that is fed to the first riser 12 and the second stream of hot catalyst in the second hot catalyst pipe 62 that is fed to the second riser 50.

A second stream of stripped catalyst from the dense bed 28 passes in a recycle conduit 42 to provide the first stream of recycle catalyst in the first recycle catalyst pipe 22 to the first riser 12 and the second stream of recycle catalyst in the second recycle catalyst pipe 71 to the second riser 50.

A support lug 64 extends between the first disengagement chamber 11 and the second disengagement chamber 60 in the second disengagement chamber. The support lug 64 is oriented radially, so as to impede the second stream of product gas from swirling in the second disengagement chamber 60 after initial disengagement from the second stream of disengaged catalyst. The support lug 64 or more may be located upwardly of the second discharge opening 49 so as not to impede swirling during the initial disengagement. By use of the support lug 64, the first disengagement chamber 11 may be supported by the second disengagement chamber 60 which may be supported by the reactor vessel 10. For example, the second disengagement chamber 60 may have a support lug (not shown) fastened to the shell 15 of the reactor vessel 10 to support the second disengagement chamber or the second disengagement chamber may be fastened to the plenum 29 through the top of the gas recovery conduit 26. On the other hand, the second disengagement chamber 60 may be supported by the first disengagement chamber 11 by use of the support lug 64. A support lug (not shown) may be fastened to the wall 17 of the first disengagement chamber 11 to the shell 15 of the reactor vessel for support thereby. Alternately, the first disengagement chamber 11 and second disengagement chamber 60 may be fastened independently to the shell 15 of the reactor vessel 10 for support thereby. The support lug 64 may be configured with the purpose of impeding swirl.

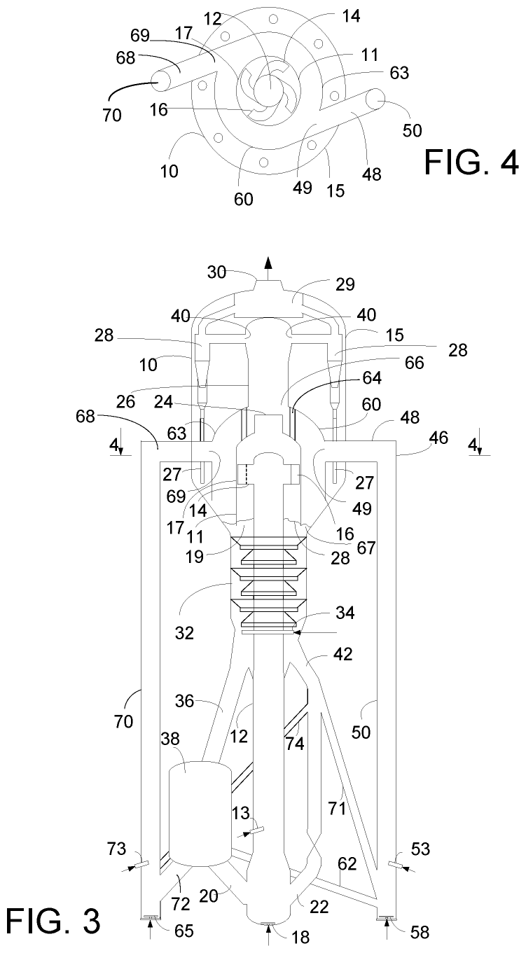

FIG. 3 shows a sectional elevation of an FCC reactor vessel analogous to the FCC reactor shown in FIG. 1, wherein more than one additional, distinct third FCC reactor riser 70 is shown in accordance with the present invention. In FIG. 3, a second riser 50 and a distinct third riser 70 run external to the reactor vessel 10, although the use of more or fewer external risers are anticipated. The third riser 70 comprises a third discharge opening 69 in the second disengagement chamber 60. Like the second discharge opening 49, the second disengaging chamber 60 contains the third discharge opening 69. In an embodiment, a second horizontal transfer line 68 of the third riser 70 terminates in the second disengagement chamber 60. The third discharge opening 69 tangentially discharges a second mixture of product gas and catalyst into the second disengagement chamber 60. In other embodiments, the second horizontal transfer line 68 may be exchanged for an alternative connector such as a T-type connector or an elbow with a more acute or more obtuse angle. The discharge openings 49 and 69 are symmetrically arranged around the second disengagement chamber 60.

A third hydrocarbon feedstock is distributed into the third riser 70 from a feed distributor 73 or a plurality thereof near the base of the third riser. A third stream of catalyst may be fluidized with steam distributed from a distributor 65 at a bottom of the third riser 70. A steam flow rate of about 25 wt % to about 50 wt % of the third hydrocarbon feedstock may be added to the third riser 312. The third hydrocarbon feedstock is contacted with a third stream of catalyst in the third riser 70. The third stream of catalyst may be provided by a mixture of a third stream of hot catalyst from a third hot catalyst pipe 72 and a third stream of recycle catalyst from a third recycle catalyst pipe 74. The third hydrocarbon feedstock vaporizes and converts or cracks to product gas comprising hydrocarbons of smaller molecular weight than the feedstock. Molar expansion and vaporization causes the third hydrocarbon feedstock and product gas to rapidly ascend the third riser 70 entraining the third stream of catalyst as a third mixture of catalyst and product gas. The third stream of catalyst may comprise about 0.005 wt % to about 1.2 wt % coke.

As best seen in FIG. 4, the second horizontal transfer line 68 enters the reactor vessel 10, through the wall 15 and then tangentially enters the wall 63 of the second disengagement chamber 60 at the third discharge opening 69 at 180 degrees from the second discharge opening 49. The third discharge opening 69 is located in the wall 63 of the second disengagement chamber 60. Tangential discharge of the third mixture of catalyst and product gases through the third discharge opening 69 from the third riser 70 produces a swirling helical pattern about the interior of the second disengagement chamber 60 along with the tangential discharge of a second mixture of catalyst and product gases through the second discharge opening 49 from the second riser 50. The disengagement of the second mixture of catalyst and product gas into the second stream of product gas and a third mixture of catalyst and product gas into a third stream of product gas is conducted outwardly and concentrically of the disengagement of the first mixture of catalyst and product gas into the first stream of product gas and the first stream of disengaged catalyst.

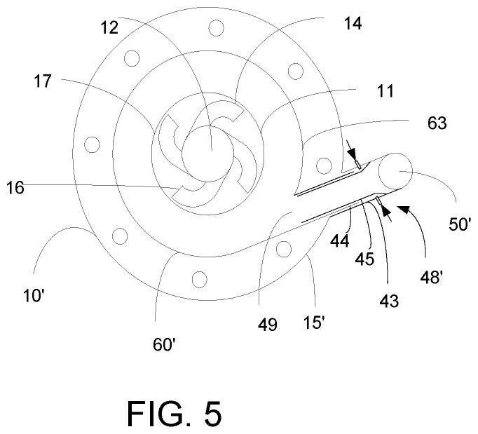

FIG. 5 depicts an alternative embodiment of FIG. 2 that employs a transfer line 48′ for transferring catalyst and product gas from the second riser 50′ to the second disengagement chamber 60′. The transfer line 48′ comprises a riser outlet pipe 45 and a disengagement inlet pipe 44 that slide relative to each other. A reactor tube 43 fashioned from the wall 15′, extending from and in communication with the reactor vessel 10′ contains the riser outlet pipe 45 and the disengagement inlet pipe 44. An inert fluidizing gas such as steam may be fed into the annulus between the reactor tube 43 and the riser outlet pipe 45 and or the disengagement inlet pipe 44 to contain gas and catalyst within its flow path. The arrangement of the transfer line 48′ allows for thermal expansion of the transfer line 48′, the riser 50′ and the second disengagement chamber 60′ independently of each other. FIG. 5 illustrates the disengagement inlet pipe 44 around the riser outlet pipe 45, but it could be the reverse.

### EXAMPLE

A computation fluid dynamics (CFD) study was conducted to ascertain the separation efficiency of the apparatus described in the present disclosure. Separation efficiency is defined as the quantity of catalyst particles separated by the disengagement system out of the total quantity of catalyst particles entering the system. The separated catalyst particles return to the dense bed of catalyst below the disengagement system. The study considered a reactor at a typical operating condition of 138 kPa gauge (20 psig) and 582° C. (1080° F.). For a conventional disengagement system which contains a standalone first disengagement chamber, the CFD estimated separation efficiency was 96.0%.

For the apparatus described in the present disclosure, the first disengagement chamber (11) had an estimated separation efficiency of 95.4% and the second disengagement chamber (60) had an estimated separation efficiency of 99.2%. The aggregate separation efficiency of the apparatus described in the present disclosure was observed to be 96.5% which is superior to the conventional disengagement system having standalone first disengagement chamber.

### SPECIFIC EMBODIMENTS

While the following is described in conjunction with specific embodiments, it will be understood that this description is intended to illustrate and not limit the scope of the preceding description and the appended claims.

A first embodiment of the invention is a process for catalytic conversion of a hydrocarbon feedstock, the process comprising contacting a first hydrocarbon feedstock and a first stream of catalyst in a first riser to produce a first mixture of catalyst and product gases, the first riser terminating within a reactor vessel; contacting a second hydrocarbon feedstock and a second stream of catalyst in a second riser to produce a second mixture of catalyst and product gases; discharging the first mixture of catalyst and product gases from the first riser into a first disengagement chamber within the reactor vessel; and discharging the second mixture of catalyst and product gases from the second riser into a second disengagement chamber. An embodiment of the invention is one, any or all of prior embodiments in this paragraph up through the first embodiment in this paragraph further comprising disengaging the first mixture of catalyst and product gas into a first stream of product gas and a first stream of disengaged catalyst in the first disengagement chamber and separately disengaging the second mixture of catalyst and product gas into a second stream of product gas and a second stream of disengaged catalyst in the second disengagement chamber. An embodiment of the invention is one, any or all of prior embodiments in this paragraph up through the first embodiment in this paragraph further comprising mixing the first stream of product gas and the second stream of product gas after the disengagement of the first stream of product gas from the first stream of disengaged catalyst and the disengagement of the second stream of product gas from the second stream of disengaged catalyst. An embodiment of the invention is one, any or all of prior embodiments in this paragraph up through the first embodiment in this paragraph further comprising mixing the first stream of disengaged catalyst and the second stream of disengaged catalyst after the disengagement of the first stream of product gas from the first stream of disengaged catalyst and the disengagement of the second stream of product gas from the second stream of disengaged catalyst. An embodiment of the invention is one, any or all of prior embodiments in this paragraph up through the first embodiment in this paragraph further comprising disengaging the first mixture of catalyst and product gas into the first stream of product gas and the first stream of disengaged catalyst and disengaging the second mixture of catalyst and product gas into the second stream of product gas and the second stream of disengaged catalyst concentrically with each other. An embodiment of the invention is one, any or all of prior embodiments in this paragraph up through the first embodiment in this paragraph further comprising discharging the first mixture of catalyst and product gases from the riser centrifugally through a swirl duct into the first disengagement chamber. An embodiment of the invention is one, any or all of prior embodiments in this paragraph up through the first embodiment in this paragraph further comprising tangentially discharging the second mixture of catalyst and product gases from the second riser into the second disengagement chamber.

A second embodiment of the invention is an apparatus for separating catalyst from a product gas, the apparatus comprising a first riser comprising a first discharge opening, the first riser terminating within a reactor vessel; a second riser comprising a second discharge opening; a first disengagement chamber located within the reactor vessel and containing the first discharge opening; a second disengagement chamber located within the same reactor vessel and containing the second discharge opening. An embodiment of the invention is one, any or all of prior embodiments in this paragraph up through the second embodiment in this paragraph wherein the first riser is centrally located in the first disengagement chamber and the second discharge opening is located in a wall of the second disengagement chamber. An embodiment of the invention is one, any or all of prior embodiments in this paragraph up through the second embodiment in this paragraph wherein the second disengagement chamber surrounds the first disengagement chamber. An embodiment of the invention is one, any or all of prior embodiments in this paragraph up through the second embodiment in this paragraph wherein the second disengagement chamber is annular to the first disengagement chamber. An embodiment of the invention is one, any or all of prior embodiments in this paragraph up through the second embodiment in this paragraph wherein the inner wall of the second disengagement chamber is the outer wall of the first disengagement chamber. An embodiment of the invention is one, any or all of prior embodiments in this paragraph up through the second embodiment in this paragraph further comprising a first upper outlet of the first disengagement chamber located proximate to a second upper outlet of the second disengagement chamber. An embodiment of the invention is one, any or all of prior embodiments in this paragraph up through the second embodiment in this paragraph wherein the first upper outlet and the second upper outlet are below a cyclone inlet. An embodiment of the invention is one, any or all of prior embodiments in this paragraph up through the second embodiment in this paragraph wherein the first disengagement chamber is supported by the second disengagement chamber which is supported by the reactor vessel or the second disengagement chamber is supported by the first disengagement chamber which is supported by the reactor vessel. An embodiment of the invention is one, any or all of prior embodiments in this paragraph up through the second embodiment in this paragraph wherein a support lug extends between the first disengagement chamber and the second disengagement chamber in the second disengagement chamber; the lug is oriented radially so as to impede a mixture of catalyst and product gas from swirling in the second disengagement chamber. An embodiment of the invention is one, any or all of prior embodiments in this paragraph up through the second embodiment in this paragraph further comprising a third riser comprising a third discharge opening and the second disengagement chamber containing the third discharge opening. An embodiment of the invention is one, any or all of prior embodiments in this paragraph up through the second embodiment in this paragraph wherein the second riser includes a transfer conduit for transferring catalyst and product gas to the second disengagement chamber, the transfer conduit comprising a riser outlet pipe and a disengagement inlet pipe that slide relative to each other. An embodiment of the invention is one, any or all of prior embodiments in this paragraph up through the second embodiment in this paragraph further comprising a first lower outlet of the first disengagement chamber located proximate to a second lower outlet of the second disengagement chamber. An embodiment of the invention is one, any or all of prior embodiments in this paragraph up through the second embodiment in this paragraph wherein the first lower outlet and the second lower outlet are above a catalyst stripper.

A third embodiment of the invention is an apparatus for separating catalyst from product gas, the apparatus comprising a first riser comprising a first discharge opening, the first riser terminating within a reactor vessel; a second riser comprising a second discharge opening; a first disengagement chamber located within the reactor vessel and containing the first discharge opening; a second disengagement chamber located within the same reactor vessel, surrounding the first disengagement chamber and containing the second discharge opening. An embodiment of the invention is one, any or all of prior embodiments in this paragraph up through the third embodiment in this paragraph wherein the first riser is centrally located in the first disengagement chamber and the second discharge opening is located in a side wall of the second disengagement chamber. An embodiment of the invention is one, any or all of prior embodiments in this paragraph up through the third embodiment in this paragraph wherein the second disengagement chamber is annular to the first disengagement chamber. An embodiment of the invention is one, any or all of prior embodiments in this paragraph up through the third embodiment in this paragraph wherein the inner wall of the second disengagement chamber is the outer wall of the first disengagement chamber.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for catalytic conversion of a hydrocarbon feedstock, the process comprising:
contacting a first hydrocarbon feedstock and a first stream of catalyst in a first riser to produce a first mixture of catalyst and product gases, the first riser terminating within a reactor vessel;
contacting a second hydrocarbon feedstock and a second stream of catalyst in a second riser to produce a second mixture of catalyst and product gases;
discharging the first mixture of catalyst and product gases from the first riser into a first disengagement chamber within the reactor vessel; and
discharging the second mixture of catalyst and product gases from the second riser into a second disengagement chamber.

2. The process of claim 1 further comprising disengaging the first mixture of catalyst and product gas into a first stream of product gas and a first stream of disengaged catalyst in the first disengagement chamber and separately disengaging the second mixture of catalyst and product gas into a second stream of product gas and a second stream of disengaged catalyst in the second disengagement chamber.

3. The process of claim 2 further comprising mixing the first stream of product gas and the second stream of product gas after the disengagement of the first stream of product gas from the first stream of disengaged catalyst and the disengagement of the second stream of product gas from the second stream of disengaged catalyst.

4. The process of claim 2 further comprising mixing the first stream of disengaged catalyst and the second stream of disengaged catalyst after the disengagement of the first stream of product gas from the first stream of disengaged catalyst and the disengagement of the second stream of product gas from the second stream of disengaged catalyst.

5. The process of claim 2 further comprising disengaging the first mixture of catalyst and product gas into the first stream of product gas and the first stream of disengaged catalyst and disengaging the second mixture of catalyst and product gas into the second stream of product gas and the second stream of disengaged catalyst concentrically with each other.

6. The process of claim 1 further comprising discharging the first mixture of catalyst and product gases from the riser centrifugally through a swirl duct into the first disengagement chamber.

7. The process of claim 1 further comprising tangentially discharging the second mixture of catalyst and product gases from the second riser into the second disengagement chamber.

8. An apparatus for separating catalyst from a product gas, the apparatus comprising:
a first riser comprising a first discharge opening, the first riser terminating within a reactor vessel;
a second riser comprising a second discharge opening;
a first disengagement chamber located within the reactor vessel and containing the first discharge opening;
a second disengagement chamber located within the same reactor vessel and containing the second discharge opening.

9. The apparatus of claim 8 wherein the first riser is centrally located in the first disengagement chamber and the second discharge opening is located in a wall of the second disengagement chamber.

10. The apparatus of claim 8 wherein the second disengagement chamber surrounds the first disengagement chamber.

11. The apparatus of claim 8 wherein the second disengagement chamber is annular to the first disengagement chamber.

12. The apparatus of claim 8 wherein the inner wall of the second disengagement chamber is the outer wall of the first disengagement chamber.

13. The apparatus of claim 8 further comprising a first upper outlet of the first disengagement chamber located proximate to a second upper outlet of the second disengagement chamber.

14. The apparatus of claim 13 wherein the first upper outlet and the second upper outlet are below a cyclone inlet.

15. The apparatus of claim 10 wherein the first disengagement chamber is supported by the second disengagement chamber which is supported by the reactor vessel or the second disengagement chamber is supported by the first disengagement chamber which is supported by the reactor vessel.

16. The apparatus of claim 15 wherein a support lug extends between the first disengagement chamber and the second disengagement chamber in said second disengagement chamber; said lug is oriented radially so as to impede a mixture of catalyst and product gas from swirling in the second disengagement chamber.

17. The apparatus of claim 8 further comprising a third riser comprising a third discharge opening and said second disengagement chamber containing the third discharge opening.

18. The apparatus of claim 8 wherein said second riser includes a transfer conduit for transferring catalyst and product gas to the second disengagement chamber, said transfer conduit comprising a riser outlet pipe and a disengagement inlet pipe that slide relative to each other.

19. The apparatus of claim 8 further comprising a first lower outlet of the first disengagement chamber located proximate to a second lower outlet of the second disengagement chamber.

20. The apparatus of claim 19 wherein the first lower outlet and the second lower outlet are above a catalyst stripper.

21. An apparatus for separating catalyst from product gas, the apparatus comprising:
a first riser comprising a first discharge opening, the first riser terminating within a reactor vessel;
a second riser comprising a second discharge opening;
a first disengagement chamber located within the reactor vessel and containing the first discharge opening;
a second disengagement chamber located within the same reactor vessel, surrounding the first disengagement chamber and containing the second discharge opening.

22. The apparatus of claim 21 wherein the first riser is centrally located in the first disengagement chamber and the second discharge opening is located in a side wall of the second disengagement chamber.

23. The apparatus of claim 21 wherein the second disengagement chamber is annular to the first disengagement chamber.

24. The apparatus of claim 21 wherein the inner wall of the second disengagement chamber is the outer wall of the first disengagement chamber.
